(19) United States
(12) Patent Application Publication
(10) Pub. No.: US 2023/0180251 A1
(43) Pub. Date: Jun. 8, 2023

(54) METHOD AND APPARATUS FOR DETERMINING CONFIGURATION OF SEARCH SPACE SET, AND COMPUTER READABLE STORAGE MEDIUM

(71) Applicant: SPREADTRUM COMMUNICATIONS (SHANGHAI) CO., LTD., Pudong New Area, Shanghai (CN)

(72) Inventors: Huayu ZHOU, Shanghai (CN); Sicong ZHAO, Shanghai (CN); Zhengang PAN, Shanghai (CN)

(21) Appl. No.: 17/925,467

(22) PCT Filed: May 12, 2021
(86) PCT No.: PCT/CN2021/093257

§ 371 Date: Nov. 15, 2022

(30) Foreign Application Priority Data
May 15, 2020 (CN) 202010413837.4

(51) Int. Cl. H04W 72/23

(52) U.S. Cl. CPC H04W 72/23

(57) ABSTRACT

A method and apparatus for determining configuration of a search space set, and a computer readable storage medium are provided. The method includes receiving signaling; and determining the configuration of the search space set based on the signaling.

### CROSS-REFERENCE TO RELATED APPLICATIONS

This is the U.S. national stage of application No. PCT/CN2021/093257, filed on May 12, 2021. Priority under 35 U.S.C. § 119(a) and 35 U.S.C. § 365(b) is claimed from Chinese Application No. 202010413837.4 filed May 15, 2020, the disclosure of which is also incorporated herein by reference.

### TECHNICAL FIELD

The present disclosure generally relates to radio communication technology field, and more particularly, to a method and apparatus for determining configuration of a search space set, and a computer readable storage medium.

### BACKGROUND

With the development of communication technology, New Radio (NR) in future can support low-complexity user equipment (UE). Low-complexity UEs are low in cost and applicable for Machine Type Communication (MTC) or Internet of Things (IoT).

Compared with conventional UEs, low-complexity UEs have smaller bandwidth, fewer antennas, lower capacity, and relaxed UE processing time. Specifically, a bandwidth is reduced from 100 MHz to 50 MHz, 20 MHz, 10 MHz or 5 MHz, and a number of receiving antennas is reduced from 4 to 2 or 1. A decrease in the bandwidth and the number of antennas causes a decrease in coverage or effective cell radius. This is because that the decrease in the bandwidth leads to a decrease in a maximum Aggregation Level (AL) of a Physical Downlink Control Channel (PDCCH), resulting in a decrease in a coding gain, and the decrease in the number of receiving antennas leads to a decrease in a receiving diversity gain.

Therefore, some mechanisms for PDCCH coverage recovery are introduced, including prolonging a duration of a Control Resource Set (CORESET), thereby increasing the maximum aggregation level, and PDCCH repeated transmission, in which a UE can merge multiple PDCCHs to indirectly increase PDCCH time domain resources.

During an initial access procedure, the UE monitors a common PDCCH configured by a Master Information Block (MIB), where a search space set corresponding to the common PDCCH configured by the MIB is generally called search space set 0 (as it has an identity of 0). As low-complexity UEs require coverage recovery, search space set 0 for low-complexity UEs needs to correspond to different coverage recovery configurations. For example, when a coverage loss is 3 dB, a configuration corresponding to coverage recovery of 3 dB is required, and when the coverage loss is 6 dB, a configuration corresponding to coverage recovery of 6 dB is required.

### SUMMARY

Embodiments of the present disclosure may enable low-complexity UEs to adaptively determine configuration of a search space set based on a coverage recovery requirement.

In an embodiment of the present disclosure, a method for determining configuration of a search space set is provided, including receiving signaling; and determining the configuration of the search space set based on the signaling.

In an embodiment of the present disclosure, a computer-readable storage medium having computer instructions stored therein is provided, wherein when the computer instructions are executed, any one of the above methods is performed.

In an embodiment of the present disclosure, an apparatus for determining configuration of a search space set is provided and includes a memory and a processor, wherein the memory has computer instructions stored therein, and when the processor executes the computer instructions, any one of the above methods is performed.

### BRIEF DESCRIPTION OF THE DRAWINGS

FIG. 1 is a flow chart of a method for determining configuration of a search space set according to an embodiment; and

FIG. 2 is a structural diagram of an apparatus for determining configuration of a search space set according to an embodiment.

### DETAILED DESCRIPTION

As described in the background, it becomes an urgent problem how the low-complexity UEs can adaptively determine configuration of the search space set based on a coverage recovery requirement.

In the embodiments of the present disclosure, by receiving signaling from a network side, and determining configuration of a search space set based on the signaling, a low-complexity UE may be able to adaptively determine configuration of the search space set.

In order to clarify the objects, characteristics and advantages of the disclosure, embodiments of present disclosure will be described in detail in conjunction with accompanying drawings.

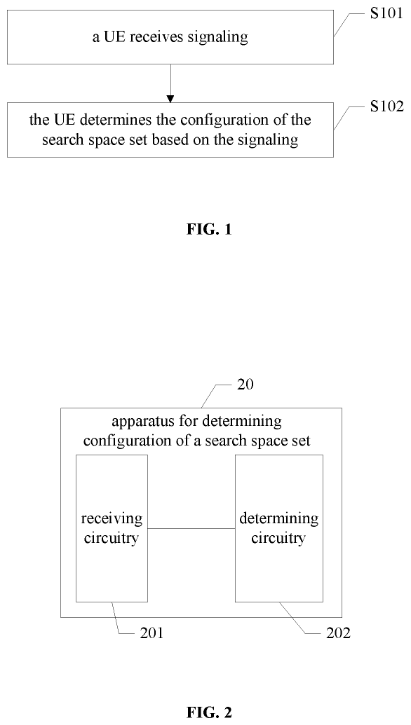

In an embodiment, a method for determining configuration of a search space set is provided. Referring to FIG. 1, details of the method are provided via specific steps below.

In some embodiments, the method including S101 and S102 may be performed by a chip (such as a baseband chip) with a data processing function in a UE, or by a chip module containing a chip with a data processing function in the UE.

In S101, a UE receives signaling.

In some embodiments, the UE may receive the signaling from a network side. The signaling received from the network side may be a MIB signaling.

In some embodiments, the UE may be a low-complexity UE. In practice, a low-complexity UE has smaller bandwidth, fewer antennas, lower capacity, and relaxed UE processing time. Specifically, a bandwidth is reduced from 100 MHz to 50 MHz, 20 MHz, 10 MHz or 5 MHz, and a number of receiving antennas is reduced from 4 to 2 or 1.

In S102, the UE determines the configuration of the search space set based on the signaling.

In some embodiments, after receiving the signaling, the UE may determine the configuration of the search space set based on the signaling. The configuration of the search space set determined by the UE may be a number of PDCCH repetitions for the search space set.

In some embodiments, determining the configuration of the search space set may include determining PDCCH configuration of the search space set with an identity of 0 which is also called search space set 0. Generally, the search space set (or search space) with the identity of 0 is a search space set (or search space) configured by MIB, or by PDCCH-ConfigSIB1, or by SearchSpaceZero. The PDCCH configuration of the search space set with the identity of 0 determined by the UE may be the number of PDCCH repetitions for the search space set with the identity of 0.

In some embodiments, the UE may determine the number of PDCCH repetitions for the search space set based on parameters and/or signaling. The parameters and/or signaling may include at least one of the following: a coverage recovery value; at least one of bandwidth of the UE and a number of receiving antennas of the UE; bandwidth of a control resource set, a duration of the control resource set, and the number of receiving antennas of the UE; a maximum aggregation level and the number of receiving antennas of the UE; or a type of the UE. The bandwidth of the UE may include bandwidth supported by the UE, maximum bandwidth supported by UE, channel bandwidth of the UE, channel bandwidth supported by the UE, or maximum channel bandwidth supported by the UE.

The UE may obtain the bandwidth of the control resource set and the duration of the control resource set via signaling, where the control resource set may be the control resource set with the identity of 0, referred to as CORESET 0. Generally, the control resource set with the identity of 0 is a control resource set configured by MIB, or by PDCCH-ConfigSIB1, or by ControlResourceSetZero. The UE may obtain the maximum aggregation level via signaling, where the maximum aggregation level may be obtained based on the configuration of the control resource set which includes the bandwidth and the duration of the control resource set, and the control resource set may be the control resource set with the identity of 0. The UE may obtain the type of UE based on at least one of the bandwidths of the UE and the number of the receiving antennas of the UE.

Accordingly, the UE may also use the above parameters and/or signaling to determine the number of PDCCH repetitions for the search space set with the identity of 0. Correspondence between the parameters and the number of PDCCH repetitions for the search space set is described below.

In some embodiments, the coverage recovery value may be associated with the number of PDCCH repetitions for the search space set. That is, the larger the coverage recovery value, the greater the number of PDCCH repetitions for the search space set.

In some embodiments, it is determined that the number of PDCCH repetitions for the search space set is 2 based on the coverage recovery value being 3 dB; it is determined that the number of PDCCH repetitions for the search space set is 4 based on the coverage recovery value being 6 dB; and it is determined that the number of PDCCH repetitions for the search space set is 8 based on the coverage recovery value being 9 dB.

Accordingly, the coverage recovery value may also be associated with the number of PDCCH repetitions for the search space set with the identity of 0.

In some embodiments, it is determined that the number of PDCCH repetitions for the search space set with the identity of 0 is 2 based on the coverage recovery value being 3 dB; it is determined that the number of PDCCH repetitions for the search space set with the identity of 0 is 4 based on the coverage recovery value being 6 dB; and it is determined that the number of PDCCH repetitions for the search space set with the identity of 0 is 8 based on the coverage recovery value being 9 dB.

In some embodiments, the UE may determine the number of PDCCH repetitions for the search space set based on at least one of the bandwidths of the UE and the number of the receiving antennas of the UE. The UE may determine the number of PDCCH repetitions for the search space set merely based on the bandwidth of the UE. The UE may determine the number of PDCCH repetitions for the search space set merely based on the number of the receiving antennas of the UE. The UE may determine the number of PDCCH repetitions for the search space set based on both the bandwidth of the UE and the number of the receiving antennas of the UE.

In some embodiments, the UE determines that the number of PDCCH repetitions for the search space set is W based on the bandwidth of the UE being less than X Physical Resource Blocks (PRBs) and the number of the receiving antennas of the UE being Z.

In some embodiments, the UE determines that the number of PDCCH repetitions for the search space set is 2 based on the bandwidth of the UE being less than X PRBs and the number of the receiving antennas of the UE being Z.

In this case, X may be 48 and Z may be 2, so that the number of PRBs of the control resource set is 24. When the duration of the control resource set is 1 symbol length, the maximum aggregation level is 4, and if the number of PDCCH repetitions of the search space set is 2, an equivalent maximum aggregation level (i.e., an equivalent maximum aggregation level of two control resource sets) is 8. When the duration of the control resource set is 2 symbol length, the maximum aggregation level is 8, and if the number of PDCCH repetitions of the search space set is 2, the equivalent maximum aggregation level is 16.

In some embodiments, the UE determines that the number of PDCCH repetitions for the search space set is 4 based on the bandwidth of the UE being less than X PRBs and the number of the receiving antennas of the UE being Z.

In this case, X may be 48 and Z may be 1, so that the number of PRBs of the control resource set is 24. When the duration of the control resource set is 1 symbol length, the maximum aggregation level is 4, and if the number of PDCCH repetitions of the search space set is 4, an equivalent maximum aggregation level (i.e., an equivalent maximum aggregation level of four control resource sets) is 16. When the duration of the control resource set is 2 symbol length, the maximum aggregation level is 8, and if the number of PDCCH repetitions of the search space set is 4, the equivalent maximum aggregation level is 32.

In some embodiments, the UE determines that the number of PDCCH repetitions for the search space set is 8 based on the bandwidth of the UE being less than X PRBs and the number of the receiving antennas of the UE being Z.

In this case, X may be 48 and Z may be 1, so that the number of PRBs of the control resource set is 24. When the duration of the control resource set is 1 symbol length, the maximum aggregation level is 4, and if the number of PDCCH repetitions of the search space set is 8, an equivalent maximum aggregation level (i.e., an equivalent maximum aggregation level of eight control resource sets) is 32. When the duration of the control resource set is 2 symbol length, the maximum aggregation level is 8, and if the number of PDCCH repetitions of the search space set is 8, the equivalent maximum aggregation level is 64.

In some embodiments, the UE determines the number of PDCCH repetitions for the search space set based on the number of the receiving antennas of the UE. In some embodiments, the UE determines that the number of PDCCH repetitions for the search space set is W based on the number of the receiving antennas of the UE being Z.

In some embodiments, the UE determines that the number of PDCCH repetitions for the search space set is 2 based on the number of the receiving antennas of the UE being Z.

In this case, Z may be 2, so that the number of PRBs of the control resource set is 24. When the duration of the control resource set is 1 symbol length, the maximum aggregation level is 4, and if the number of PDCCH repetitions of the search space set is 2, an equivalent maximum aggregation level (i.e., an equivalent maximum aggregation level of two control resource sets) is 8. When the duration of the control resource set is 2 symbol length, the maximum aggregation level is 8, and if the number of PDCCH repetitions of the search space set is 2, the equivalent maximum aggregation level is 16.

In some embodiments, the UE determines that the number of PDCCH repetitions for the search space set is 4 based on the number of the receiving antennas of the UE being Z.

In this case, Z may be 1, so that the number of PRBs of the control resource set is 24. When the duration of the control resource set is 1 symbol length, the maximum aggregation level is 4, and if the number of PDCCH repetitions of the search space set is 4, an equivalent maximum aggregation level (i.e., an equivalent maximum aggregation level of four control resource sets) is 16. When the duration of the control resource set is 2 symbol length, the maximum aggregation level is 8, and if the number of PDCCH repetitions of the search space set is 4, the equivalent maximum aggregation level is 32.

In some embodiments, the UE determines that the number of PDCCH repetitions for the search space set is 8 based on the number of the receiving antennas of the UE being Z.

In this case, Z may be 1, so that the number of PRBs of the control resource set is 24. When the duration of the control resource set is 1 symbol length, the maximum aggregation level is 4, and if the number of PDCCH repetitions of the search space set is 8, an equivalent maximum aggregation level (i.e., an equivalent maximum aggregation level of eight control resource sets) is 32. When the duration of the control resource set is 2 symbol length, the maximum aggregation level is 8, and if the number of PDCCH repetitions of the search space set is 8, the equivalent maximum aggregation level is 64.

Accordingly, in some embodiments, the UE may determine the number of PDCCH repetitions for the search space set with the identity of 0 based on at least one of the bandwidths of the UE and the number of the receiving antennas of the UE. The UE may determine the number of PDCCH repetitions for the search space set with the identity of 0 merely based on the bandwidth of the UE. The UE may determine the number of PDCCH repetitions for the search space set merely based on the number of the receiving antennas of the UE. The UE may determine the number of PDCCH repetitions for the search space set with the identity of 0 based on both the bandwidth of the UE and the number of the receiving antennas of the UE.

In some embodiments, the UE determines that the number of PDCCH repetitions for the search space set with the identity of 0 is W based on the bandwidth of the UE being less than X PRBs and the number of the receiving antennas of the UE being Z.

In some embodiments, the UE determines that the number of PDCCH repetitions for the search space set with the identity of 0 is 2 based on the bandwidth of the UE being less than X PRBs and the number of the receiving antennas of the UE being Z.

In this case, X may be 48 and Z may be 2, so that the number of PRBs of the control resource set is 24. When the duration of the control resource set is 1 symbol length, the maximum aggregation level is 4, and if the number of PDCCH repetitions of the search space set is 2, an equivalent maximum aggregation level (i.e., an equivalent maximum aggregation level of two control resource sets) is 8. When the duration of the control resource set is 2 symbol length, the maximum aggregation level is 8, and if the number of PDCCH repetitions of the search space set is 2, the equivalent maximum aggregation level is 16.

In some embodiments, the UE determines that the number of PDCCH repetitions for the search space set with the identity of 0 is 4 based on the bandwidth of the UE being less than 48 PRBs and the number of the receiving antennas of the UE being Z.

In this case, X may be 48 and Z may be 1, so that the number of PRBs of the control resource set is 24. When the duration of the control resource set is 1 symbol length, the maximum aggregation level is 4, and if the number of PDCCH repetitions of the search space set is 4, an equivalent maximum aggregation level (i.e., an equivalent maximum aggregation level of four control resource sets) is 16. When the duration of the control resource set is 2 symbol length, the maximum aggregation level is 8, and if the number of PDCCH repetitions of the search space set is 4, the equivalent maximum aggregation level is 32.

In some embodiments, the UE determines that the number of PDCCH repetitions for the search space set with the identity of 0 is 8 based on the bandwidth of the UE being less than 48 PRBs and the number of the receiving antennas of the UE being Z.

In this case, X may be 48 and Z may be 1, so that the number of PRBs of the control resource set is 24. When the duration of the control resource set is 1 symbol length, the maximum aggregation level is 4, and if the number of PDCCH repetitions of the search space set is 8, an equivalent maximum aggregation level (i.e., an equivalent maximum aggregation level of eight control resource sets) is 32. When the duration of the control resource set is 2 symbol length, the maximum aggregation level is 8, and if the number of PDCCH repetitions of the search space set is 8, the equivalent maximum aggregation level is 64.

Accordingly, in some embodiments, the UE determines the number of PDCCH repetitions for the search space set with the identity of 0 based on the number of the receiving antennas of the UE. In some embodiments, the UE determines that the number of PDCCH repetitions for the search space set with the identity of 0 is W based on the number of the receiving antennas of the UE being Z.

In some embodiments, the UE determines that the number of PDCCH repetitions for the search space set with the identity of 0 is 2 based on the number of the receiving antennas of the UE being Z.

In this case, Z may be 2, so that the number of PRBs of the control resource set is 24. When the duration of the control resource set is 1 symbol length, the maximum aggregation level is 4, and if the number of PDCCH repetitions of the search space set is 2, an equivalent maximum aggregation level (i.e., an equivalent maximum aggregation level of two control resource sets) is 8. When the duration of the control resource set is 2 symbol length, the maximum aggregation level is 8, and if the number of PDCCH repetitions of the search space set is 2, the equivalent maximum aggregation level is 16.

In some embodiments, the UE determines that the number of PDCCH repetitions for the search space set with the identity of 0 is 4 based on the number of the receiving antennas of the UE being Z.

In this case, Z may be 1, so that the number of PRBs of the control resource set is 24. When the duration of the control resource set is 1 symbol length, the maximum aggregation level is 4, and if the number of PDCCH repetitions of the search space set is 4, an equivalent maximum aggregation level (i.e., an equivalent maximum aggregation level of four control resource sets) is 16. When the duration of the control resource set is 2 symbol length, the maximum aggregation level is 8, and if the number of PDCCH repetitions of the search space set is 4, the equivalent maximum aggregation level is 32.

In some embodiments, the UE determines that the number of PDCCH repetitions for the search space set with the identity of 0 is 8 based on the number of the receiving antennas of the UE being Z.

In this case, Z may be 1, so that the number of PRBs of the control resource set is 24. When the duration of the control resource set is 1 symbol length, the maximum aggregation level is 4, and if the number of PDCCH repetitions of the search space set is 8, an equivalent maximum aggregation level (i.e., an equivalent maximum aggregation level of eight control resource sets) is 32. When the duration of the control resource set is 2 symbol length, the maximum aggregation level is 8, and if the number of PDCCH repetitions of the search space set is 8, the equivalent maximum aggregation level is 64.

In some embodiments, the UE may determine the number of PDCCH repetitions for the search space set based on bandwidth of a control resource set, a duration of the control resource set, and the number of receiving antennas of the UE.

Accordingly, in some embodiments, the UE may determine the number of PDCCH repetitions for the search space set with the identity of 0 based on bandwidth of a control resource set with the identity of 0, a duration of the control resource set with the identity of 0, and the number of receiving antennas of the UE.

Accordingly, in some embodiments, the UE may determine the number of PDCCH repetitions for the search space set with the identity of 0 based on bandwidth of a control resource set, a duration of the control resource set, and the number of receiving antennas of the UE.

In some embodiments, the UE may determine the number of PDCCH repetitions for the search space set based on a maximum aggregation level and the number of receiving antennas of the UE. In some embodiments, the maximum aggregation level is determined by the bandwidth of the control resource set and the duration of the control resource set. In some embodiments, the maximum aggregation level is determined by a frequency domain resource (a number of control resources in unit) of the control resource set and the duration of the control resource set.

In some embodiments, the UE determines that the number of PDCCH repetitions for the search space set is W based on the maximum aggregation level being Y and the number of the receiving antennas of the UE being Z.

In some embodiments, when the maximum aggregation level is Y and the number of the receiving antennas is Z, it is determined that the number of PDCCH repetitions for the search space set is 2. Y may be 16, and Z may be 1. If the number of PDCCH repetitions for the search space set is 2, an equivalent maximum aggregation level (i.e., an equivalent maximum aggregation level of two control resource sets) is 32.

In some embodiments, when the maximum aggregation level is Y and the number of the receiving antennas is Z, it is determined that the number of PDCCH repetitions for the search space set is 2. Y may be 8, and Z may be 2. If the number of PDCCH repetitions for the search space set is 2, an equivalent maximum aggregation level (i.e., an equivalent maximum aggregation level of two control resource sets) is 16.

In some embodiments, when the maximum aggregation level is Y and the number of the receiving antennas is Z, it is determined that the number of PDCCH repetitions for the search space set is 2. Y may be 4, and Z may be 4. If the number of PDCCH repetitions for the search space set is 2, an equivalent maximum aggregation level (i.e., an equivalent maximum aggregation level of two control resource sets) is 8.

In some embodiments, when the maximum aggregation level is Y and the number of the receiving antennas is Z, it is determined that the number of PDCCH repetitions for the search space set is 4. Y may be 8, and Z may be 1. If the number of PDCCH repetitions for the search space set is 4, an equivalent maximum aggregation level (i.e., an equivalent maximum aggregation level of four control resource sets) is 32.

In some embodiments, when the maximum aggregation level is Y and the number of the receiving antennas is Z, it is determined that the number of PDCCH repetitions for the search space set is 4. Y may be 4, and Z may be 2. If the number of PDCCH repetitions for the search space set is 4, an equivalent maximum aggregation level (i.e., an equivalent maximum aggregation level of four control resource sets) is 16.

In some embodiments, when the maximum aggregation level is Y and the number of the receiving antennas is Z, it is determined that the number of PDCCH repetitions for the search space set is 8. Y may be 4, and Z may be 1. If the number of PDCCH repetitions for the search space set is 8, an equivalent maximum aggregation level (i.e., an equivalent maximum aggregation level of eight control resource sets) is 32.

Accordingly, in some embodiments, the UE may determine the number of PDCCH repetitions for the search space set with the identity of 0 based on the maximum aggregation level and the number of receiving antennas of the UE. In some embodiments, the maximum aggregation level is determined by the bandwidth of the control resource set with the identity of 0 and the duration of the control resource set with the identity of 0. In some embodiments, the maximum aggregation level is determined by a frequency domain resource (a number of control resources in unit) of the control resource set with the identity of 0 and the duration of the control resource set with the identity of 0. Alternatively, the maximum aggregation level is determined by the bandwidth of the control resource set and the duration of the control resource set. In some embodiments, the maximum aggregation level is determined by a frequency domain resource (a number of control resources in unit) of the control resource set and the duration of the control resource set.

In some embodiments, when the maximum aggregation level is Y and the number of the receiving antennas is Z, it is determined that the number of PDCCH repetitions for the search space set with the identity of 0 is 2. Y may be 16, and Z may be 1. If the number of PDCCH repetitions for the search space set is 2, an equivalent maximum aggregation level (i.e., an equivalent maximum aggregation level of two control resource sets) is 32.

In some embodiments, when the maximum aggregation level is Y and the number of the receiving antennas is Z, it is determined that the number of PDCCH repetitions for the search space set with the identity of 0 is 2. Y may be 8, and Z may be 2. If the number of PDCCH repetitions for the search space set is 2, an equivalent maximum aggregation level (i.e., an equivalent maximum aggregation level of two control resource sets) is 16.

In some embodiments, when the maximum aggregation level is Y and the number of the receiving antennas is Z, it is determined that the number of PDCCH repetitions for the search space set with the identity of 0 is 2. Y may be 4, and Z may be 4. If the number of PDCCH repetitions for the search space set is 2, an equivalent maximum aggregation level (i.e., an equivalent maximum aggregation level of two control resource sets) is 8.

In some embodiments, when the maximum aggregation level is Y and the number of the receiving antennas is Z, it is determined that the number of PDCCH repetitions for the search space set with the identity of 0 is 4. Y may be 8, and Z may be 1. If the number of PDCCH repetitions for the search space set is 4, an equivalent maximum aggregation level (i.e., an equivalent maximum aggregation level of four control resource sets) is 32.

In some embodiments, when the maximum aggregation level is Y and the number of the receiving antennas is Z, it is determined that the number of PDCCH repetitions for the search space set with the identity of 0 is 4. Y may be 4, and Z may be 2. If the number of PDCCH repetitions for the search space set is 4, an equivalent maximum aggregation level (i.e., an equivalent maximum aggregation level of four control resource sets) is 16.

In some embodiments, when the maximum aggregation level is Y and the number of the receiving antennas is Z, it is determined that the number of PDCCH repetitions for the search space set with the identity of 0 is 8. Y may be 4, and Z may be 1. If the number of PDCCH repetitions for the search space set is 8, an equivalent maximum aggregation level (i.e., an equivalent maximum aggregation level of eight control resource sets) is 32.

In some embodiments, the UE may determine the number of PDCCH repetitions for the search space set based on a type of the UE.

In some embodiments, the type of the UE may be determined by a preset coverage recovery value, or by at least one of the bandwidths of the UE and the number of the receiving antennas of the UE, or by the maximum aggregation level and the number of the receiving antennas of the UE. It could be understood that the type of the UE may be determined by at least two of the above three kinds of parameters.

In some embodiments, if the type of the UE is determined by a preset coverage recovery value, it is determined that the type of the UE is type 3 based on the coverage recovery value being 3 dB, it is determined that the type of the UE is type 6 based on the coverage recovery value being 6 dB, or it is determined that the type of the UE is type 9 based on the coverage recovery value being 9 dB.

In some embodiments, the type of the UE may be determined by at least one of the bandwidths of the UE and the number of the receiving antennas of the UE.

When the bandwidth of the UE is less than X PRBs and the number of the receiving antennas is Z, it may be determined that the type of the UE is type 3, where X may be 48, and Z may be 2. When the bandwidth of the UE is less than X PRBs and the number of the receiving antennas is Z, it may be determined that the type of the UE is type 6 or type 9, where X may be 48, and Z may be 1.

When the number of the receiving antennas is Z, it may be determined that the type of the UE is type 3, where Z may be 2. When the number of the receiving antennas is Z, it may be determined that the type of the UE is type 6 or type 9, where Z may be 1.

In some embodiments, the type of the UE may be determined by the maximum aggregation level and the number of the receiving antennas of the UE.

When the maximum aggregation level is Y and the number of the receiving antennas is Z, it may be determined that the type of the UE is type 3, where Y may be 8, and Z may be 2. When the maximum aggregation level is Y and the number of the receiving antennas is Z, it may be determined that the type of the UE is type 3, where Y may be 4, and Z may be 4. When the maximum aggregation level is Y and the number of the receiving antennas is Z, it may be determined that the type of the UE is type 6, where Y may be 8, and Z may be 1.

Alternatively, when the maximum aggregation level is Y and the number of the receiving antennas is Z, it may be determined that the type of the UE is type 6, where Y may be 4, and Z may be 2. When the maximum aggregation level is Y and the number of the receiving antennas is Z, it may be determined that the type of the UE is type 9, where Y may be 4, and Z may be 1.

In some embodiments, it is determined that the number of PDCCH repetitions of the search space set is 2 based on the type of the UE being type 3, it is determined that the number of PDCCH repetitions of the search space set is 4 based on the type of the UE being type 6, or it is determined that the number of PDCCH repetitions of the search space set is 8 based on the type of the UE being type 9.

Accordingly, in some embodiments, it is determined that the number of PDCCH repetitions of the search space set with the identity of 0 is 2 based on the type of the UE being type 3, it is determined that the number of PDCCH repetitions of the search space set with the identity of 0 is 4 based on the type of the UE being type 6, or it is determined that the number of PDCCH repetitions of the search space set with the identity of 0 is 8 based on the type of the UE being type 9.

In some embodiments, the UE determines the number of PDCCH repetitions for the search space set further based on a table parameter of the search space set.

In some embodiments, the UE determines the number of PDCCH repetitions for the search space set based on a parameter M in a table corresponding to the search space set, which includes searching the parameter M in the table corresponding to the search space set. The parameter M is a time expansion factor corresponding to a start slot of a PDCCH monitoring occasion. Specifically, the UE determines the start slot n₀ of the PDCCH monitoring occasion is n₀=(O·2^{μ}+└i·M┘)modNₛₗₒₜ^{frame,μ}, where i is a candidate synchronization signal block index, the parameter O represents is an offset, μ∈{0,1,2,3} is a parameter corresponding to a subcarrier spacing of PDCCH, and the parameter M is the time expansion factor.

For example, if M=4, it is determined that the number of PDCCH repetitions for the search space set is 4.

Accordingly, in some embodiments, the UE determines that the number of PDCCH repetitions for the search space set with the identity of 0 is M based on a parameter M in a table corresponding to the search space set with the identity of 0.

In some embodiments, following determining the number M of PDCCH repetitions for the search space set, the UE may further determine a start slot offset of a scheduled PDSCH. In some embodiments, the UE may determine that the start slot offset of the scheduled PDSCH is M or determine that the start slot offset of the scheduled PDSCH is (M−1).

In some embodiments, the UE may determine, based on the parameter M in the table corresponding to the search space set, that the number of PDCCH repetitions for the search space set is half of the parameter M in the table corresponding to the search space set, i.e., M/2.

For example, if M=4, it is determined that the number of PDCCH repetitions for the search space set is 2.

Accordingly, in some embodiments, the UE determines that the number of PDCCH repetitions for the search space set with the identity of 0 is M/2 based on a parameter M in a table corresponding to the search space set with the identity of 0.

In some embodiments, following determining the number M/2 of PDCCH repetitions for the search space set, the UE may further determine a start slot offset of a scheduled PDSCH. In some embodiments, the UE may determine that the start slot offset of the scheduled PDSCH is M/2 or determine that the start slot offset of the scheduled PDSCH is (M/2−1).

In some embodiments, the UE may determine the number of PDCCH repetitions for the search space set based on a QCL parameter of SSBs. Specifically, it may be determined that PDCCH monitoring occasions associated with the SSBs having a QCL relation overlap. The QCL parameter is also known as a parameter Q and can be denoted as N_{SSB}^{QCL}. The UE obtains the QCL parameter via ssbPositionQCL-Relationship signaling or

MIB signaling. Based on the QCL parameter, the UE can know whether there is a QCL relationship between SSBs and can also obtain an SSB index.

Accordingly, in some embodiments, the UE may determine the number of PDCCH repetitions for the search space set with the identity of 0 based on a QCL parameter of SSBs, which includes determining that PDCCH monitoring occasions associated with the SSBs having a QCL relation overlap.

In some embodiments, following determining the number of PDCCH repetitions for the search space set, the UE may further determine a monitoring occasion of a PDCCH. The UE may determine a start time slot and a start symbol corresponding to the monitoring occasion of the PDCCH, and determine to perform W times of consecutive monitoring, where W is a number of PDCCH repetitions for the search space set.

FIG. 2 is a structural diagram of an apparatus 20 for determining configuration of a search space set according to an embodiment. The apparatus 20 includes a receiving circuitry 201 and a determining circuitry 202.

The receiving circuitry 201 is configured to receive signaling, and the determining circuitry 202 is configured to determine the configuration of the search space set based on the signaling.

In some embodiments, more details of the receiving circuitry 201 and the determining circuitry 202 may be referred to the above descriptions of S101 and S102 and are not repeated here.

In some embodiments, the apparatus 20 may correspond to a chip (such as a baseband chip) with a data processing function in a UE, or to a chip module containing a chip (such as a baseband chip) with a data processing function in a UE, or to a UE.

In some embodiments, modules/units included in each apparatus and product described in the above embodiments may be software modules/units, hardware modules/units, or a combination of software modules/units and hardware modules/units.

For example, for each apparatus or product applied to or integrated in a chip, each module/unit included therein may be implemented by hardware such as circuits; or, at least some modules/units may be implemented by a software program running on a processor integrated inside the chip, and the remaining (if any) part of the modules/units may be implemented by hardware such as circuits. For each apparatus or product applied to or integrated in a chip module, each module/unit included therein may be implemented by hardware such as circuits. Different modules/units may be disposed in a same component (such as a chip or a circuit module) or in different components of the chip module. Or at least some modules/units may be implemented by a software program running on a processor integrated inside the chip module, and the remaining (if any) part of the modules/units may be implemented by hardware such as circuits. For each apparatus or product applied to or integrated in a terminal, each module/unit included therein may be implemented by hardware such as circuits. Different modules/units may be disposed in a same component (such as a chip or a circuit module) or in different components of the terminal. Or at least some modules/units may be implemented by a software program running on a processor integrated inside the terminal, and the remaining (if any) part of the modules/units may be implemented by hardware such as circuits.

In an embodiment of the present disclosure, a computer-readable storage medium having computer instructions stored therein is provided, wherein when the computer instructions are executed, any one of the above methods is performed.

In an embodiment of the present disclosure, an apparatus for determining configuration of a search space set which includes a memory, and a processor is provided, wherein the memory has computer instructions stored therein, and when the processor executes the computer instructions, any one of the above methods is performed.

Those skilled in the art could understand that all or part of steps in the various methods in the above embodiments can be completed by instructing relevant hardware through a program, and the program can be stored in any computer-readable storage medium which includes a ROM, a RAM, a magnetic disk, or an optical disk.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A method for determining configuration of a search space set, comprising:
receiving signaling; and
determining the configuration of the search space set based on the signaling.

2. The method according to claim 1, wherein the signaling is Master Information Block (MIB) signaling.

3. The method according to claim 1, wherein said determining the configuration of the search space set comprises:
determining Physical Downlink Control Channel (PDCCH) configuration for the search space set.

4. The method according to claim 3, wherein said determining PDCCH configuration for the search space set comprises:
determining PDCCH configuration for the search space set with an identity of 0.

5. The method according to claim 4, wherein said determining PDCCH configuration for the search space set with an identity of 0 comprises:
determining a number of PDCCH repetitions for the search space set with the identity of 0.

6. The method according to claim 3, wherein said determining the configuration of the search space set comprises:
determining a number of PDCCH repetitions for the search space set.

7. The method according to claim 6, wherein said determining a number of PDCCH repetitions for the search space set comprises at least one of the following:
determining the number of PDCCH repetitions for the search space set based on a coverage recovery value;
determining the number of PDCCH repetitions for the search space set based on at least one of bandwidth of a User Equipment (UE) and a number of receiving antennas of the UE;
determining the number of PDCCH repetitions for the search space set based on bandwidth of a control resource set, a duration of the control resource set, and the number of receiving antennas of the UE;
determining the number of PDCCH repetitions for the search space set based on a maximum aggregation level and the number of receiving antennas of the UE; or
determining the number of PDCCH repetitions for the search space set based on a type of the UE.

8-10. (canceled)

11. The method according to claim 7, wherein the type of the UE is determined by at least one of the following:
the coverage recovery value;
at least one of the bandwidths of the UE and the number of the receiving antennas of the UE; or
the maximum aggregation level and the number of the receiving antennas of the UE.

12-18. (canceled)

19. The method according to claim 3, wherein said determining the number of PDCCH repetitions for the search space set comprises:
determining the number of PDCCH repetitions for the search space set based on a table parameter of the search space set.

20. The method according to claim 19, wherein said determining the number of PDCCH repetitions for the search space set based on table parameters of the search space set comprises:
determining the number of PDCCH repetitions for the search space set based on a parameter M in a table corresponding to the search space set.

21. The method according to claim 20, wherein said determining the number of PDCCH repetitions for the search space set based on a parameter M in a table corresponding to the search space set comprises:
determining that the number of PDCCH repetitions for the search space set is the parameter M in the table corresponding to the search space set.

22. The method according to claim 21, wherein following determining the number of PDCCH repetitions for the search space set, the method further comprises:
determining a start slot offset of a scheduled PDSCH based on the number of PDCCH repetitions for the search space set.

23. The method according to claim 22, wherein said determining a start slot offset of a scheduled PDSCH comprises:
determining that the start slot offset of the scheduled PDSCH is M; or
determining that the start slot offset of the scheduled PDSCH is (M−1).

24. The method according to claim 20, wherein said determining the number of PDCCH repetitions for the search space set based on a parameter M in a table corresponding to the search space set comprises:
determining that the number of PDCCH repetitions for the search space set is half of the parameter M in the table corresponding to the search space set.

25-26. (canceled)

27. The method according to claim 6, wherein said determining the number of PDCCH repetitions for the search space set comprises:
determining the number of PDCCH repetitions for the search space set based on a Quasi Co-Location (QCL) parameter of Synchronization Signal Blocks (SSBs).

28. The method according to claim 27, wherein said determining the number of PDCCH repetitions for the search space set based on a QCL parameter of SSBs comprises:
determining that PDCCH monitoring occasions associated with the SSBs having a QCL relation overlap.

29. The method according to claim 3, wherein following determining the number of PDCCH repetitions for the search space set, the method further comprises:
determining a monitoring occasion of a PDCCH.

30. The method according to claim 29, wherein said determining a monitoring occasion of a PDCCH comprises:
determining a start time slot and a start symbol corresponding to the monitoring occasion of the PDCCH, and determining to perform W times of consecutive monitoring, where W is a number of PDCCH repetitions for the search space set.

31. (canceled)

32. A non-transitory computer readable storage medium storing one or more programs, the one or more programs comprising computer instructions, which, when executed by a processor, cause the processor to:
receive signaling; and
determine configuration of a search space set based on the signaling.

33. An apparatus for determining configuration of a search space set, comprising a memory and a processor, wherein the memory stores one or more programs, the one or more programs comprising computer instructions, which, when executed by the processor, cause the processor to:
receive signaling; and
determine the configuration of the search space set based on the signaling.
